(19) United States
(12) Patent Application Publication
(10) Pub. No.: US 2007/0110085 A1
(43) Pub. Date: May 17, 2007

(54) Synchronous digital hierarchy (sdh) tributary module and sdh equipment node

(76) Inventors: Zhangzhen Jiang, Guangdong Province (CN); Zhongwen Peng, Guangdong Province (CN); Yong Tang, Guangdong Province (CN); Xingyue Quan, Guangdong Province (CN)

Correspondence Address: LADAS & PARRY LLP, 224 SOUTH MICHIGAN AVENUE, SUITE 1600, CHICAGO, IL, 60604, US

(21) Appl. No.: 10/581,231

(22) PCT Filed: Nov. 30, 2004
(86) PCT No.: PCT/CN04/01379

§ 371 Date: Jun. 2, 2006

(30) Foreign Application Priority Data
May 12, 2003 (CN) 200320127259.X

(51) Int. Cl. H04L 12/28; H04J 3/16; H04J 3/04

(52) U.S. Cl. 370/403; 370/466; 370/535

(57) ABSTRACT

The present invention provides a Synchronous Digital Hierarchy (SDH) tributary module supporting multiple service processing, which includes an SDH tributary processing unit and at least two service processing units, the SDH tributary processing unit which is connected with each of the service processing units respectively multiplexing and demultiplexing different service signals in an SDH signal, and each of the service processing units which is directly connected with a corresponding local interface respectively mapping and unmapping corresponding service signals. The tributary module further includes a multiple service cross processing unit which is connected with each of the service processing units to implement interconnection among different services. The present invention can reduce the number of board and avoid using external network line or equipment, so as to reduce the cost of equipment, facilitate the maintenance of equipment and improve the reliability of equipment.

### FIELD OF THE INVENTION

The present invention relates to the field of communication technology, and more particularly, to a Synchronous Digital Hierarchy (SDH) tributary module and an SDH equipment node using this module.

### BACKGROUND OF THE INVENTION

A Multiple Service Transport Platform (MSTP) node based on Synchronous Digital Hierarchy (SDH) refers to a multiple service node that implements, based on an SDH platform, access, processing and transport of services for Time Division Multiplex (TDM) mode, Asynchronous Transfer Mode (ATM), Ethernet, Resilient Packet Ring (RPR), etc., and provides unified network management.

SDH divides a physical channel into several time slots of different levels by time division multiplexing, each of the time slots transporting a different service. As shown in FIG. 1, an SDH equipment node usually employs a multi-W structure, which is generally divided into a line module, a cross module and a tributary module separated from each other. The line module is responsible for sending SDH signal; the cross module provides dispatch and cross of SDH signal; and the tributary module is responsible for processing SDH signal. One tributary module includes one SDH tributary processing unit that multiplexes and demultiplexes the SDH signals and one service processing unit that maps and unmaps the SDH signals and is connected directly with a local interface. For example, an ATM tributary module provides mapping of ATM signal to SDH signal and unmapping of SDH signal to ATM signal, and a Plesiochronous Digital Hierarchy (PDH) tributary module provides mapping of PDH signal to SDH signal and unmapping of SDH signal to PDH signal. An Ethernet service is mapped into an SDH signal in a tributary unit of a network element A in the SDH network, the SDH signal is cross multiplexed and then transmitted to another network element B through a line module, and an Ethernet processing module (a tributary module) of the network element B unmaps the SDH signal and sends out the Ethernet service. Currently, it is a general approach to use different tributary modules for different services (tributary modules 1-n as shown in FIG. 1).

Different tributary module processes different service, the main reason for which lies in different characteristics, different interfaces and different implementing methods for various services. For example, an ATM tributary module needs to resolve an ATM cell of 52 bytes out of SDH time slot to send to an ATM interface; while an Ethernet tributary module needs to resolve an Ethernet traffic of indefinite length out of an SDH time slot to send to an Ethernet interface.

When a service flow is to be carried by a plurality of different service signals, a plurality of different tributary modules have to be used to implement mapping and unmapping between SDH signals and service signals, and it needs to incorporate a network line or other equipment to implement. FIG. 2 shows a structural diagram of a two-level SDH network; in this two-level SDH network, the SDH network at access layer (access ring) transmits Ethernet service, and the SDH network at convergence layer (convergence ring) transmits RPR service, the SDH network at access layer being connected with an edge node of the SDH network at convergence layer. Both Ethernet and RPR are used to carry IP traffic, and the IP traffic flow needs to be sent from the SDH network at access layer to a central node of the SDH network at convergence layer, that is to say, the IP traffic over Ethernet service is sent to an edge node of the SDH network at convergence layer, unmapped into an Ethernet service by an Ethernet tributary module, accessing to an RPR processing module via a network line or other equipment and mapped into an SDH signal, and finally sent out from the central node of the SDH network at convergence layer.

As can be seen from the above, the existing SDH tributary module has poor signal processing capability, which leads to the following shortcomings of the SDH equipment node.

1. When two or more different service signals are required to carry one service flow, two or more tributary modules (usually two separate circuit boards) are required to be incorporated, thus the cost of network is increased.

2. When more than two services are to be interconnected, extra network line and other equipment or device to connect different tributary modules are required to be incorporated, thus the difficulty in network maintenance is increased and the reliability of network is lowered.

### SUMMARY OF THE INVENTION

The technique problem to be solved by this invention is to provide a SDH tributary unit supporting multiple service processing; the present invention further provides an SDH equipment node using the SDH tributary module, so as to reduce the cost of SDH equipment, facilitate the maintenance, and improve the reliability of network.

A synchronous digital hierarchy tributary module supporting multiple service processing provided by this invention includes a Synchronous Digital Hierarchy (SDH) tributary processing unit and service processing units; there are at least two service processing units connected with the SDH tributary processing unit respectively, for mapping and unmapping corresponding service signals; the SDH tributary processing unit is for multiplexing and demultiplexing multiple service signals in an SDH signal.

Each of the service processing units is connected directly to a corresponding local interface respectively.

The tributary module further includes a multiple service cross processing unit which is used to implement interconnection among different services, each service processing unit being connected to a local interface through the multiple service cross processing unit.

Furthermore, the SDH tributary processing unit separates out the service signals corresponding to different service processing units, according to different time slots corresponding to the SDH signals of different services.

A cross module of the SDH equipment node time-division multiplexes multiple service SDH signals into one SDH signal.

The services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

An SDH equipment node using the synchronous digital hierarchy tributary module provided by the invention includes a plurality of local interfaces, a plurality of line modules, a cross module connected with the line modules respectively and a plurality of SDH tributary modules connected with the cross module respectively; the SDH tributary module includes an SDH tributary processing unit and at least two service processing units connected with the SDH tributary processing unit respectively, the service processing unit being for mapping and unmapping corresponding service signal, and the SDH tributary processing unit being for multiplexing and demultiplexing multiple service signals in an SDH signal, each of the service processing units being directly connected with a corresponding local interface respectively.

For the above-mentioned SDH equipment node, the SDH tributary processing unit separates out the service signals corresponding to different service processing units, according to different time slots corresponding to the SDH signals of different services.

The cross module of the SDH equipment node time-division multiplexes multiple service SDH signals into one SDH signal.

The services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

The beneficial effect of the invention is: one tributary module generally uses one circuit board, while by using this invention, one tributary module can support two or more services and meet various service needs, thus remarkably decreasing the number of boards, and interconnection between two services can be implemented directly without using external network line or equipment. For an SDH node device employing the SDH tributary module, it improves the signal processing capability as a whole. Compared to the prior art, the SDH equipment has a lower cost with the same service processing capability, facilitates the maintenance of the SDH equipment and improves the reliability of the SDH equipment itself and the entire network. By using this invention, it only needs a single board to support, without external network line, interconnection among various services, for example, convergence of an Ethernet service onto a RPR.

### BRIEF DESCRIPTION OF THE DRAWINGS

FIG. 1 is a structural diagram of a conventional SDH equipment node;

FIG. 2 is a structural diagram of a two-level SDH network;

FIG. 3 is a structural diagram of an SDH equipment node according to an embodiment of the present invention;

FIG. 4 is a signal processing diagram of an SDH equipment node according to an embodiment of the present invention.

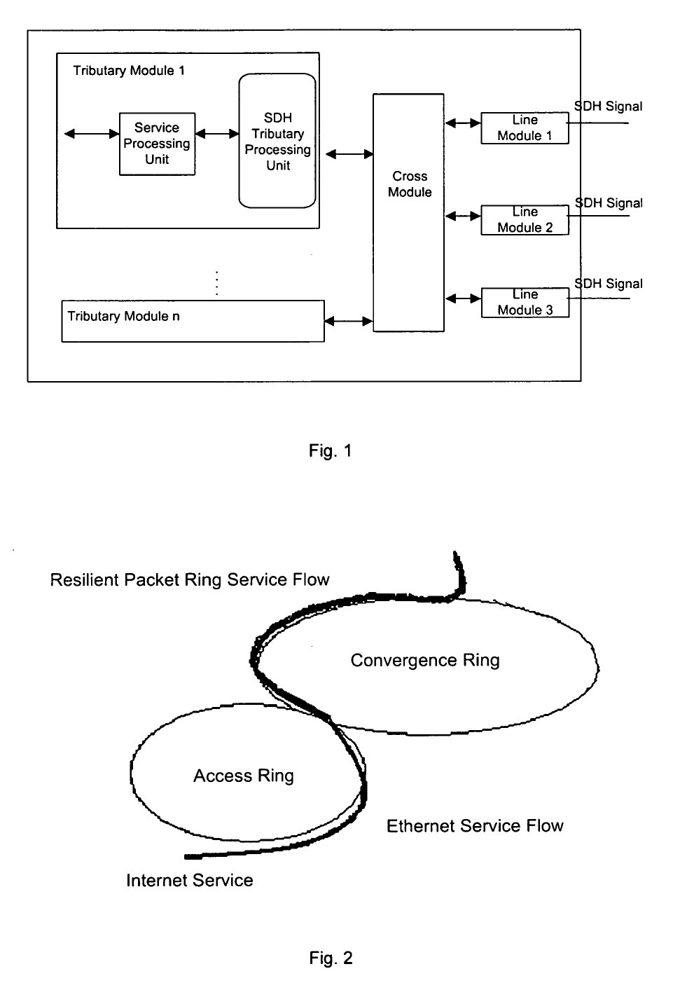

### DETAILED DESCRIPTION OF THE EMBODIMENTS

The present invention will be described below in further detail with reference to the drawings and embodiments.

The invention provides a Synchronous Digital Hierarchy (SDH) tributary module supporting multiple service processing, wherein when a service flow is to be carried by a plurality of different service signals, one and the same tributary module can be used to implement two kinds of different service processing, thus avoiding using a plurality of different tributary modules to implement mapping and unmapping between SDH signals and service signals, and the problem of incorporating network line or other equipment.

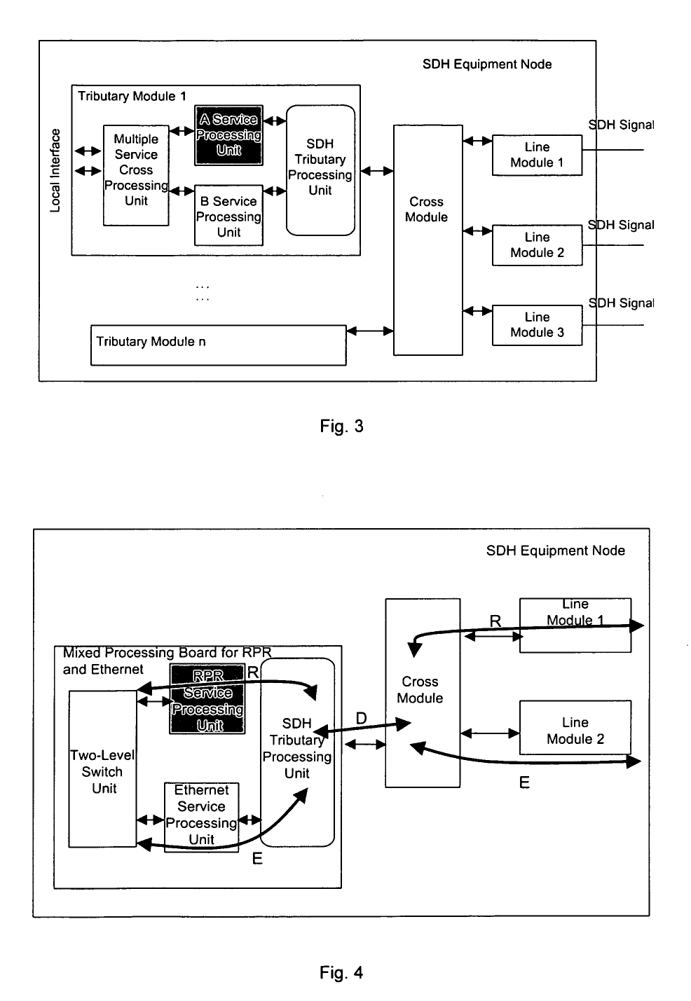

As shown in FIG. 3, which is a structural diagram of an SDH equipment node according to an embodiment of the present invention, the SDH equipment node includes a plurality of line modules (such as line module 1, line module 2, line module 3 etc.), an SDH cross module, a plurality of tributary modules (tributary modules 1-n in FIG. 3) and a plurality of local interfaces (simply drawn in the figure). The line modules are connected respectively to the cross module and the cross module is connected to all of SDH tributary modules. The SDH tributary modules are connected to the corresponding local interfaces. The line module is responsible for sending SDH signal; the cross module provides dispatch and cross of SDH signal; and the tributary module is responsible for processing SDH signal. As shown in FIG. 3, the tributary module provided in embodiments of the invention employed in the SDH equipment node includes an SDH tributary processing unit which multiplexes and demultiplexes multiple service signals in an SDH signal, and two or more service processing units (A service processing unit and B service processing unit as shown in FIG. 3) which map and unmap corresponding service signals; the SDH tributary processing unit is connected with the service processing units respectively, and each service processing unit can be connected to a local interface directly. In practice, after the signals from the SDH side are demultiplexed by the SDH tributary processing unit, the service signals corresponding to different service processing units are separated out of the demultiplexed signals according to different time slots corresponding to the SDH signals of different services, and the service signals are sent to the corresponding service processing units for unmapping; on the other hand, the services to be sent from the local to the SDH side are mapped by the service processing units respectively and sent to the SDH tributary processing unit for multiplexing, different services being multiplexed in different time slots, that is to say, the cross module of the SDH equipment node time-division multiplexes the SDH signals of multiple services into one SDH signal, and the cross module of the SDH equipment node transmits the signals of different time slots to the corresponding line modules or other tributary modules. When service interconnection is required, it can implement the interconnection among different services by connecting the corresponding service processing units via a multiple service cross processing unit.

Taking the processing of the service from the SDH side to a local interface as an example, the present invention is further described as the following.

1. At the SDH side, the equipment is configured to send two or more different services to the cross module via the line modules, the cross module performs time division multiplexing on the SDH signals of the individual services, that is to say, in the SDH cross module, the SDH signals of the individual services are time-division multiplexed into one SDH signal which is sent to the tributary module for processing.

2. In the tributary module, the SDH tributary processing unit demultiplexes the received SDH signal, and separates out different services according to different time slots corresponding to the SDH signals of two or more services.

3. After being demultiplexed, different services are sent to different service processing units for processing, unmapping of each signal being performed by the corresponding service processing unit.

4. Different services can be interconnected via the multiple service cross processing unit of the tributary module through the unmapped signals. For example, A service and B service shown in FIG. 3 can be interconnected via the multiple service cross processing unit; also, the unmapped signals can be sent to a local interface directly.

Contrary to the above-mentioned procedure, various services sent from a local interface or the multiple service cross processing unit to the SDH side are mapped by the corresponding service processing units respectively and sent to the SDH tributary processing unit for multiplexing, different services being multiplexed in different time slots, and the cross module transmits the different time slots to the corresponding line modules or other tributary modules.

As shown in FIG. 4, by using this invention, it only needs a single board to enable Ethernet service to be converged onto an RPR without external network line. Signal E in the figure is an Ethernet service signal, signal R is an RPR service signal, and signal D is a time-division multiplexed signal. An RPR service processing unit and an Ethernet service processing unit are connected via a multiple service cross processing unit (that is, a two-level switch unit in the figure). Therefore, different service processing units are connected via the switch unit directly, that is to say, Ethernet service can be converged onto an RPR, thereby implementing the interconnection between Ethernet service and RPR service without external network line, and reducing the cost of equipment.

In this invention, one tributary module can implement mapping and unmapping of multiple different services according to different time slots; one tributary module uses one circuit board, which can thus support various services simultaneously and can also implement interconnection among various services, it can therefore remarkably decrease the number of boards, and avoid using external network line or equipment.

1. A synchronous digital hierarchy tributary module supporting multiple service processing, including a Synchronous Digital Hierarchy (SDH) tributary processing unit and service processing units; wherein there are at least two service processing units connected with the SDH tributary processing unit respectively, for mapping and unmapping corresponding service signals; the SDH tributary processing unit is for multiplexing and demultiplexing multiple service signals in an SDH signal.

2. The synchronous digital hierarchy tributary module supporting multiple service processing according to claim 1, wherein each of the service processing units is connected directly to a corresponding local interface respectively.

3. The synchronous digital hierarchy tributary module supporting multiple service processing according to claim 2, wherein the tributary module further includes a multiple service cross processing unit which is used to implement interconnection among different services, each service processing unit being connected to a local interface through the multiple service cross processing unit.

4. The synchronous digital hierarchy tributary module supporting multiple service processing according to claim 1, wherein the SDH tributary processing unit separates out the service signals corresponding to different service processing units, according to different time slots corresponding to the SDH signals of different services.

5. The synchronous digital hierarchy tributary module supporting multiple service processing according to claim 1, wherein a cross module of a SDH equipment node time-division multiplexes multiple service SDH signals into one SDH signal.

6. The synchronous digital hierarchy tributary module supporting multiple service processing according to claim 1, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

7. An SDH equipment node using the synchronous digital hierarchy tributary module, including a plurality of local interfaces, a plurality of line modules, a cross module connected with the line modules respectively and a plurality of SDH tributary modules connected with the cross module respectively; wherein the SDH tributary module comprises an SDH tributary processing unit and at least two service processing units connected with the SDH tributary processing unit respectively, the service processing unit being for mapping and unmapping corresponding service signal, and the SDH tributary processing unit being for multiplexing and demultiplexing multiple service signals in an SDH signal, each of the service processing units being directly connected with a corresponding local interface respectively.

8. The SDH equipment node according to claim 7, wherein the SDH tributary processing unit separates out the service signals corresponding to different service processing units, according to different time slots corresponding to the SDH signals of different services.

9. The SDH equipment node according to claim 7, wherein the cross module of the SDH equipment node time-division multiplexes multiple service SDH signals into one SDH signal.

10. The SDH equipment node according to claim 7, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

11. The synchronous digital hierarchy tributary module supporting multiple service processing according to claim 2, wherein the SDH tributary processing unit separates out the service signals corresponding to different service processing units, according to different time slots corresponding to the SDH signals of different services.

12. The synchronous digital hierarchy tributary module supporting multiple service processing according to claim 3, wherein the SDH tributary processing unit separates out the service signals corresponding to different service processing units, according to different time slots corresponding to the SDH signals of different services.

13. The synchronous digital hierarchy tributary module supporting multiple service processing according to claim 2, wherein the cross module of the SDH equipment node time-division multiplexes multiple service SDH signals into one SDH signal.

14. The synchronous digital hierarchy tributary module supporting multiple service processing according to claim 3, wherein the cross module of the SDH equipment node time-division multiplexes multiple service SDH signals into one SDH signal.

15. The synchronous digital hierarchy tributary module supporting multiple service processing according to claim 2, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

16. The synchronous digital hierarchy tributary module supporting multiple service processing according to claim 3, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

17. The SDH equipment node according to claim 8, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.

18. The SDH equipment node according to claim 9, wherein the services to be sent from the local to the SDH side are mapped by the service processing units respectively and sent to the SDH tributary processing unit for multiplexing, different services being multiplexed in different time slots, and the cross module of the SDH equipment node transmits the signals of different time slots to the corresponding line modules or other tributary modules.
